(19) United States
(12) Patent Application Publication
(10) Pub. No.: US 2026/0189171 A1
(43) Pub. Date: Jul. 2, 2026

(54) MOTOR CONTROL DEVICE

(71) Applicant: OKUMA Corporation, Niwa-gun (JP)

(72) Inventors: Shunichi TAKASHIMA, Niwa-gun (JP); Takeshi SAKAI, Niwa-gun (JP)

(21) Appl. No.: 19/432,378

(22) Filed: Dec. 24, 2025

(30) Foreign Application Priority Data
Dec. 27, 2024 (JP) 2024-232197

(51) Int. Cl. H02P 29/40

(52) U.S. Cl. CPC H02P 29/40; H02P 2205/01

(57) ABSTRACT

A motor control device includes a speed control unit that outputs a torque command value based on a speed deviation that is a difference between a speed command value and a detected speed value; a first feedforward calculation unit that calculates a first feedforward torque command value corresponding to the amount of change in the speed command value; a second feedforward calculation unit that, when the first feedforward torque command value exceeds a maximum motor torque, outputs a second feedforward torque command value smaller than or equal to the maximum motor torque, for a period longer than a period during which the first feedforward torque command value exceeds the maximum motor torque, and adds the second feedforward torque command value to the torque command value; and a current control unit that controls a motor current based on the torque command value.

### CROSS REFERENCE TO RELATED APPLICATION

The present invention claims priority under 35 U.S.C. § 119 to Japanese Patent Application No. 2024-232197 filed on Dec. 27, 2024, which is incorporated herein by reference in its entirety including the specification, claims, drawings, and abstract.

### TECHNICAL FIELD

The present specification discloses a motor control device that controls a motor to be driven at a target speed.

### BACKGROUND

Motor control devices that drive a motor such that a detected speed value of the motor coincides with its target speed have been widely known. The motor control devices are used to control a motor that drives, for example, a spindle of a machine tool. The motor control device generates a speed command value based on a target speed, calculates a torque command value based on a speed deviation that is a difference between the speed command value and a detected speed value, and applies to the motor a current corresponding to the torque command value. Patent Document 1 discloses such a motor control device.

In many control systems, including spindle control systems, it is generally required that the motor reach a target speed in the shortest possible time. To achieve rapid acceleration/deceleration, the motor control device generates a step function-like speed command value that changes until the target speed is reached. Therefore, when the detected speed value of the motor differs from the target speed to a large extent, the motor control device outputs a torque command value that exceeds the maximum motor torque. This torque command value is limited to the maximum motor torque in limit processing. Consequently, a current corresponding to the maximum motor torque is applied to the motor. This process allows the motor to achieve acceleration and deceleration while maximizing performance.

In some cases, noise, such as detection disturbances, may be superimposed on the torque command value and adversely affect control. To address this problem, filter processing is often performed on the torque command value to remove high-frequency components. However, performing filter processing on the torque command value makes it impossible to change the torque command value sharply. This results in the problem that a maximum torque command cannot be provided immediately after the start of acceleration/deceleration.

Some proposals have been made to calculate a feedforward torque command value based on the derivative of the speed command value and to add the feedforward torque command value to the torque command value subjected to the filter processing. By doing so, it is possible to improve the responsiveness of the motor to some extent.

### CITATION LIST

### Patent Literature

Patent Document 1: JP 8-182381 A

However, when the speed command value changes sharply in a stepwise manner, the feedforward torque command value, which is proportional to the derivative of the speed command value, assumes an impulse function shape that exceeds the maximum motor torque. In this case, the feedforward torque command value is limited to the maximum motor torque in the limit processing, and the feedforward torque command value is output only momentarily. The feedforward torque command value thus is insufficient, and the responsiveness of the motor is deteriorated.

The present specification discloses a motor control device that can further improve the responsiveness of the motor.

### SUMMARY

A motor control device disclosed herein includes a speed control unit that outputs a torque command value based on a speed deviation that is a difference between a speed command value and a detected speed value; a first feedforward calculation unit that calculates a first feedforward torque command value corresponding to the amount of change in the speed command value; a second feedforward calculation unit that, when the first feedforward torque command value exceeds a maximum motor torque, outputs a second feedforward torque command value smaller than or equal to the maximum motor torque for a period longer than a period during which the first feedforward torque command value exceeds the maximum motor torque, and adds the second feedforward torque command value to the torque command value; and a current control unit that controls a motor current based on the torque command value.

In this case, the second feedforward calculation unit may calculate an acceleration/deceleration time period for a motor based on the inertia of the motor, the inertia of an object to be controlled, and the maximum motor torque, and output the maximum motor torque as the second feedforward torque command value during the acceleration/deceleration time period.

In this case, the speed command value has a step function shape, and the first feedforward torque command value has an impulse function shape. The second feedforward calculation unit may calculate the acceleration/deceleration time period ta based on Equation 1:

$$ta = ( {J}_{m} + {J}_{w} ) {\int }_{{V}_{0}}^{{V}_{r}} \frac{V}{{τ}_{max} ( V )} d V \qquad Equation 1$$

where Vr is the speed command value after it changes in a stepwise manner, V0 is the initial speed command value before it changes in the stepwise manner, Jm is the motor inertia, Jw is the motor shaft-converted load inertia of the object to be controlled, and τmax is the maximum motor torque.

The second feedforward calculation unit may also output, after the first feedforward torque command value that exceeds the maximum motor torque is calculated, the maximum motor torque as the second feedforward torque command value until the speed deviation becomes smaller than or equal to a predetermined reference value.

The second feedforward calculation unit may also calculate a second feedforward torque command value such that a time integral value of the second feedforward torque command value is equal to a time integral value of the first feedforward torque command value.

In this case, for each control cycle, the second feedforward calculation unit may calculate an intermediate torque command value by adding the first feedforward torque command value to a current time integral value, output the smaller of the intermediate torque command value and the maximum motor torque as the second feedforward torque command value, and calculate a new integral value by adding the first feedforward torque command value to the integral value and subtracting the second feedforward torque command value from the integral value.

The maximum motor torque is a torque limit value predetermined by the motor control device or an actual maximum torque, and the actual maximum torque may be defined by the following Equations 2 and 3:

$${τ}_{max} ( V ) = \frac{{P}_{max}}{{V}_{b}} ( V \leq {V}_{b} ) \qquad Equation 2$$

$${τ}_{max} ( V ) = \frac{{P}_{max}}{V} ( {V}_{b} < V ) \qquad Equation 3$$

where Pmax is a maximum motor output, Vb is the base motor speed, and V is the motor speed.

According to the technique disclosed herein, even when the first feedforward torque command value is output only momentarily, the second feedforward torque command value is output continuously, and therefore, the responsiveness of the motor can be maintained at a high level.

### BRIEF DESCRIPTION OF DRAWINGS

Embodiments of the present disclosure will be described based on the following figures, wherein:

FIG. 1 is a block diagram showing a configuration of a motor control device according to an example;

FIG. 2 shows waveforms of parameters when a step-like speed command value is input;

FIG. 3 is a block diagram showing a configuration of a motor control device according to another example;

FIG. 4 is a flowchart showing a process flow in the motor control device according to the other example;

FIG. 5 is a simplified flowchart of the flow in FIG. 4;

FIG. 6 shows a specific example of processing in FIG. 4 and FIG. 5;

FIG. 7 shows the results obtained when the processing in FIG. 4 and FIG. 5 is performed on a speed command value that is a ramp function;

FIG. 8 shows the results obtained when the speed command value exceeds the base speed as it increases;

FIG. 9 is a block diagram showing a configuration of a motor control device according to a comparative example;

FIG. 10 shows the speed during acceleration and a final torque command value in the motor control device according to the comparative example;

FIG. 11 shows the speed during deceleration and a final torque command value in the motor control device according to the comparative example; and

FIG. 12 is a block diagram showing a configuration of a motor control device according to another comparative example.

### DESCRIPTION OF EMBODIMENTS

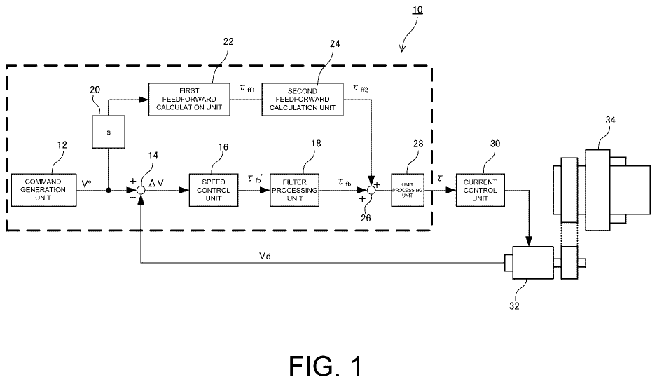

Hereinafter, a configuration of a motor control device 10 will be described with reference to the drawings. In the following description, “feedback” and “feedforward” will be abbreviated as “FB” and “FF”, respectively. FIG. 1 is a block diagram showing a configuration of the motor control device 10. The motor control device 10 controls a motor 32 that drives a target plant 34 (e.g., a machine tool spindle). A command generation unit 12 of the motor control device 10 outputs a speed command value V* from a given target speed. A subtracter 14 subtracts a detected speed value Vd from the speed command value V* and outputs a speed deviation ΔV. A speed sensor may be attached to the motor 32 to obtain the detected speed value Vd. Alternatively, a position sensor may be attached to the motor 32, and a differentiator (not shown) may differentiate a value detected by the position sensor and output the resulting value as the detected speed value Vd.

A speed control unit 16 calculates a FB torque command value ‘τfb’ based on the speed deviation ΔV. For example, the speed control unit 16 outputs a value obtained by multiplying the speed deviation ΔV by a predetermined proportional gain as the FB torque command value τfb′.

A filter processing unit 18 performs filtering on the FB torque command value ‘τfb’ to output a FB torque command value τfb from which high frequency components have been removed. Providing such a filter processing unit 18 makes it possible to reduce adverse effects on control caused by superimposition of noise, such as detection disturbances.

An adder 26 adds the FB torque command value τfb and a second FF torque command value τff2 described below. An output value from the adder 26 is subjected to limit processing by a limit processing unit 28. That is, the motor 32 has a maximum allowable motor torque τmax. The limit processing unit 28 limits the output value from the adder 26 to this maximum motor torque τmax.

The maximum motor torque τmax may be an actual maximum torque of the motor 32 or a value obtained by limiting the actual maximum torque with a torque limit value τlim in the control device. The actual maximum motor torque τmax is a function of the motor speed V and is defined by Equations 2 and 3:

$${τ}_{max} ( V ) = \frac{{P}_{max}}{{V}_{b}} ( V \leq {V}_{b} ) \qquad Equation 2$$

$${τ}_{max} ( V ) = \frac{{P}_{max}}{V} ( {V}_{b} < V ) . \qquad Equation 3$$

In Equations 2 and 3, Pmax is a maximum motor output, and Vb is the base motor speed. The maximum motor output Pmax is a value defined as (base rotation speed)×(torque at base rotation speed). The maximum motor output Pmax, the maximum motor speed, and the maximum instantaneous motor torque are all determined by the specifications of the motor 32. The maximum motor output Pmax is thus considered to be the maximum output according to the motor specifications.

The limit processing unit 28 outputs a final torque command value τ. A current control unit 30 applies a current corresponding to this final torque command value τ. The current control unit 30 may include an inverter, for example. When a current is applied, the motor 32 is driven.

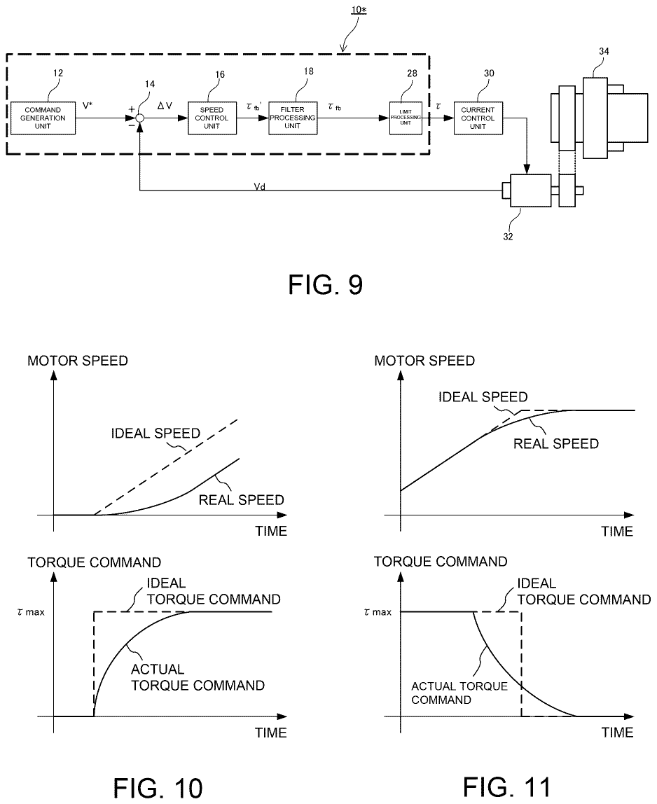

Here, there are two factors that make it impossible to achieve a steep torque command change in the above-described configuration. The factors will be explained with reference to FIG. 9 to FIG. 11. FIG. 9 is a block diagram showing a motor control device 10* according to a comparative example. FIG. 10 and FIG. 11 show the motor speed V and a final torque command value τ during acceleration and deceleration, respectively, in the motor control device 10*. In FIG. 10 and FIG. 11, the dashed lines represent the ideal motor speed V and an ideal final torque command value τ, while the solid lines represent the actual motor speed V and an actual final torque command value τ obtained as a result of control by the motor control device 10*. The motor control device 10* according to the comparative example differs from the motor control device 10 of the present example in that it does not output FF torque command values τff1 and τff2.

The first factor that makes it impossible to achieve a steep torque command change is the presence of the filter processing unit 18. Although providing the filter processing unit 18 makes it possible to reduce the influences of disturbances, it also impedes high-frequency response. Consequently, as shown in FIG. 10, the step-like torque command value τ changes to have a round shape. This in turn slows down the change in motor speed V, resulting in poor response. The second factor that makes it impossible to achieve a steep torque command change is feedback characteristics. In the case of the motor control device 10* according to the comparative example, which does not output the FF torque command values τff1 and τff2, as the detected speed value Vd approaches the speed command value V*, the torque command value based on the proportional gain becomes smaller, and as shown in FIG. 11, the step-like torque command value τ changes to have a round shape. This also slows down the change in motor speed V, resulting in poor response. Although it is possible to increase the proportional gain to alleviate this problem, this may increase the risk of adverse effects due to mechanical resonance, detection noise, etc. Furthermore, although it is also possible to apply feedback based on integral gain, there is a risk that the detected speed value Vd may overshoot the speed command value V*. For this reason, it is difficult to set a high value for the integral gain.

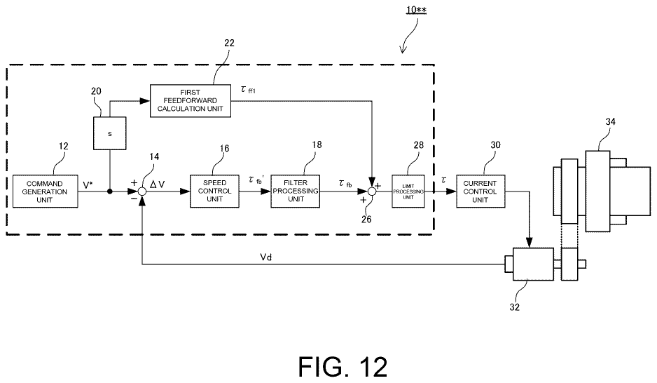

In some cases, it is proposed to add a first FF calculation unit 22, as shown in FIG. 12. In the case of a motor control device 10** according to another comparative example shown in FIG. 12, the first FF calculation unit 22 calculates a first FF torque command value τff1 based on the derivative of the speed command value V*. For example, the first FF torque command value τff1 is a value obtained by multiplying the derivative of the speed command value V* by a predetermined proportional gain. Then, by adding the calculated first FF torque command value τff1 to the FB torque command value τfb, responsiveness is improved.

However, the configuration of FIG. 12 cannot support step-like speed command values V*. That is, when the speed command value V* is step-like, its derivative and thus the first FF torque command value τff1, has an impulse function shape. Furthermore, when the first FF torque command value τff1 exceeds the maximum motor torque τmax, the excess is limited by the limit processing. In this case, compensation of the torque command value by the first FF torque command value τff1 is instantaneous and cannot prevent deterioration in responsiveness.

Therefore, in the present example, in addition to the first FF calculation unit 22, a second FF calculation unit 24 is provided. This will be explained in detail below. As shown in FIG. 1, the motor control device 10 has a differentiator 20, the first FF calculation unit 22, and the second FF calculation unit 24.

The differentiator 20 differentiates the speed command value V*. The first FF calculation unit 22 calculates the first FF torque command value τff1 based on the derivative of the speed command value V*. The first FF torque command value τff1 is calculated, for example, by multiplying the derivative of the speed command value V* by a predetermined proportional gain.

The second FF calculation unit 24 calculates and outputs the second FF torque command value τff2 based on the first FF torque command value τff1. When τff1≤τmax, τff2=τff1. On the other hand, when the first FF torque command value τff1 exceeds the maximum motor torque τmax, the second FF calculation unit 24 outputs a value smaller than or equal to the maximum motor torque τmax as the second FF torque command value τff2, for a period longer than the period during which τff1>τmax. More specifically, in this case, the second FF torque command value τff2 is a value whose time integral value is approximately the same as the time integral value of the first FF torque command value τff1. The process of calculating the second FF torque command value τff2 will be described below.

The second FF calculation unit 24 calculates the duration for which the second FF torque command value τff2 is output, based on the motor shaft-converted load inertia Jw. Specifically, the second FF calculation unit 24 calculates the acceleration/deceleration time period ta required to reach the speed command value V* when the maximum motor torque τmax is output, as the duration for which the second FF torque command value τff2 is output. The acceleration/deceleration time period ta is calculated using the following Equation 1:

$$ta = ( {J}_{m} + {J}_{w} ) {\int }_{{V}_{0}}^{{V}_{r}} \frac{V}{{τ}_{max} ( V )} dV . \qquad Equation 1$$

Here, Vr is the speed command value after it changes in a stepwise manner, and V0 is the speed command value before it changes in the stepwise manner (hereinafter referred to as the “initial speed command value”). Furthermore, Jm is the motor inertia, and Jw is the motor shaft-converted load inertia. The “maximum motor torque τmax” in Equation 1 and the following description may be a value calculated using Equations 2 and 3 or may be a value obtained by limiting output values of Equations 2 and 3 by the torque limit value τlim for control purposes.

In any case, the second FF calculation unit 24 calculates the acceleration/deceleration time period ta based on Equation 1 when the first FF torque command value τff1 exceeds the maximum motor torque τmax. Then, until the calculated acceleration/deceleration time period ta elapses, it continues to output the maximum motor torque τmax as the second FF torque command value τff2. When the first FF torque command value τff1 is smaller than or equal to the maximum motor torque τmax, the second FF calculation unit 24 outputs τff2=τff1.

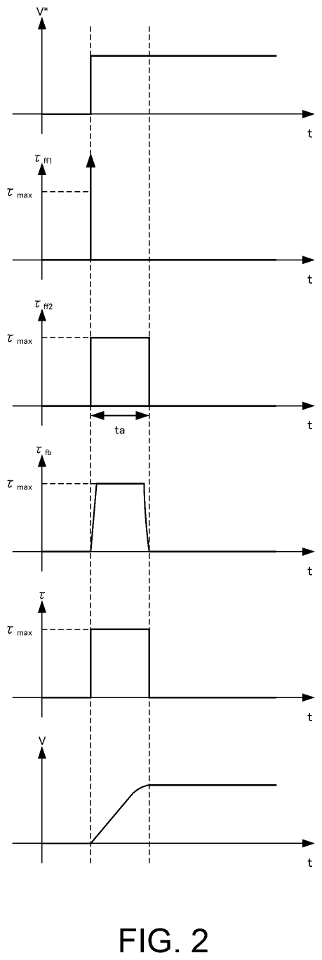

FIG. 2 shows waveforms of parameters when a step-like speed command value V* is input. As shown in the first row of FIG. 2, it is assumed that the speed command value V* that changes stepwise is input. In this case, the first FF torque command value τff1 has an impulse function shape that exceeds the maximum motor torque τmax, as shown in the second row of FIG. 2. The second FF calculation unit 24 calculates the acceleration/deceleration time period ta when τff1>τmax. It then continues to output the maximum motor torque τmax until the acceleration/deceleration time period ta elapses, as shown in the third row of FIG. 2.

On the other hand, as shown in the fourth row of FIG. 2, the FB torque command value τfb rises and falls gradually due to the influence of the filter processing unit 18. This FB torque command value τfb is added to the second FF torque command value τff2 and is subjected to the limit processing by the limit processing unit 28. As a result, a pulse-shaped final torque command value τ as shown in the fifth row of FIG. 2 is obtained. By applying a current to the motor 32 based on this final torque command value τ, the speed changes sharply as shown in the sixth row of FIG. 2, and the target speed can be reached in a short time.

As is clear from the above explanation, in the present example, even when the first FF torque command value τff1 is an impulse function, τff2=τmax is continuously output. The torque shortage due to the filter processing is thus compensated for by the second FF torque command value τff2, thereby ensuring high responsiveness. The second FF calculation unit 24 may output τff2=τff1 regardless of the magnitude of the first FF torque command value τff1 when τff1 is not an impulse function shape. In this case, the second FF calculation unit 24 may sequentially calculate the derivative of the first FF torque command value τff1 and determine whether it has an impulse function shape based on the amount of change in the derivative.

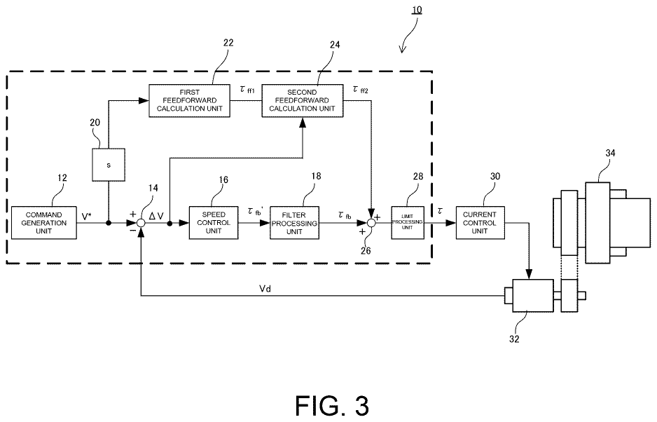

Next, another example of the motor control device 10 will be described. FIG. 3 is a diagram showing a configuration of the other example of the motor control device 10. Again, in the example of FIG. 3, when τff1>τmax, the second FF calculation unit 24 also outputs a second FF torque command value τff2, which is smaller than or equal to the maximum motor torque τmax, for the period longer than the period during which τff1>τmax. In addition, the second FF torque command value τff2 has a time integral value that is approximately the same as the time integral value of the first FF torque command value τff1.

More specifically, when τff1>τmax is input, the second FF calculation unit 24 continues to output the maximum motor torque τmax as the second FF torque command value τff2 until the speed deviation ΔV becomes smaller than or equal to a predetermined reference value Vdef. The reference value Vdef is not particularly limited, but may be, for example, a value that is regarded as substantially zero. As shown in FIG. 3, to implement this control, the speed deviation ΔV is input to the second FF calculation unit 24.

Again, in this case, when the first FF torque command value τff1 is an impulse function, τff2=τmax is continuously output. The torque that is insufficient in the feedback control is compensated for by the second FF torque command value τff2, thereby ensuring high responsiveness. In addition, in the present example, the second FF calculation unit 24 may output τff2=τff1 regardless of the magnitude of the first FF torque command value τff1 when τff1 is not an impulse function shape.

Next, another example of the motor control device 10 will be described. The block diagram of the motor control device 10 of the present example is the same as that of FIG. 1 and therefore will be omitted. In the present example, the time integral value of the second FF torque command value τff2 is made to coincide with the time integral value of the first FF torque command value τff1. More specifically, the second FF calculation unit 24 sequentially adds the first FF torque command value τff1 to the integral value τstk (initial value is 0) and sequentially subtracts the second FF torque command value τff2 from it. The second FF calculation unit 24 also sequentially outputs τff2=τmax when τstk>τmax and outputs τff2=τstk when τstk≤τmax.

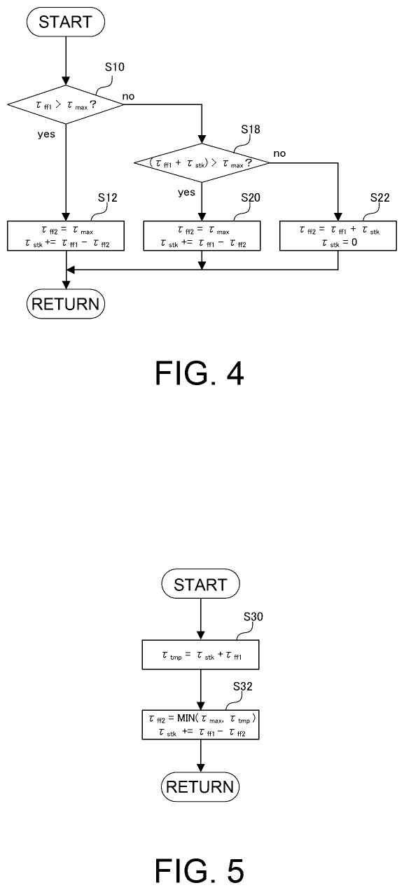

FIG. 4 is a flowchart showing the flow of calculating the second FF torque command value τff2 in the present example. The integral value τstk is set to an initial value of 0. As shown in FIG. 4, the second FF calculation unit 24 checks whether the first FF torque command value τff1 exceeds the maximum motor torque τmax (S10). When τff1>τmax, the second FF calculation unit 24 outputs the maximum motor torque τmax as the second FF torque command value τff2 (S12). This second FF torque command value τff2 is added to the FB torque command value τfb. The second FF calculation unit 24 also adds the first FF torque command value τff1 to the integral value τstk and subtracts the second FF torque command value τff2 therefrom, to thereby update the integral value τstk. The procedure then returns to the first step (S12).

On the other hand, when τff1≤τmax, the second FF calculation unit 24 checks whether the sum of the first FF torque command value τff1 and the integral value τstk exceeds the maximum motor torque τmax (S18).

When the sum exceeds the maximum motor torque τmax, the second FF calculation unit 24 outputs τff2=τmax (S20). The second FF calculation unit 24 also adds the first FF torque command value τff1 to the integral value τstk and subtracts the second FF torque command value τff2 therefrom, to thereby update the integral value τstk. The procedure then returns to the first step (S20).

On the other hand, when, in step S18, the sum of the first FF torque command value τff1 and the integral value τstk does not exceed the maximum motor torque τmax, the second FF calculation unit 24 outputs, as the second FF torque command value τff2, the value obtained by adding the current integral value τstk to the first FF torque command value τff1 (S22). The second FF calculation unit 24 also sets a new integral value τstk to 0, and the procedure returns to the first step (S22).

FIG. 5 is a simplified flowchart of the flow of FIG. 4. In FIG. 5, the initial values of the integral value τstk and the intermediate torque command value τtmp are both 0. The second FF calculation unit 24 calculates, for each control cycle tc, an intermediate torque command value τtmp by adding the current first FF torque command value τff1 to the current integral value τstk (S30). The second FF calculation unit 24 then outputs the smaller of the intermediate torque command value τtmp and the maximum motor torque τmax, as the second FF torque command value τff2 (S32). The second FF calculation unit 24 also calculates a new integral value τstk by adding the first FF torque command value τff1 to the current integral value τstk and subtracting the second FF torque command value τff2 therefrom (S32). Thereafter, the same process steps are repeated in sequence.

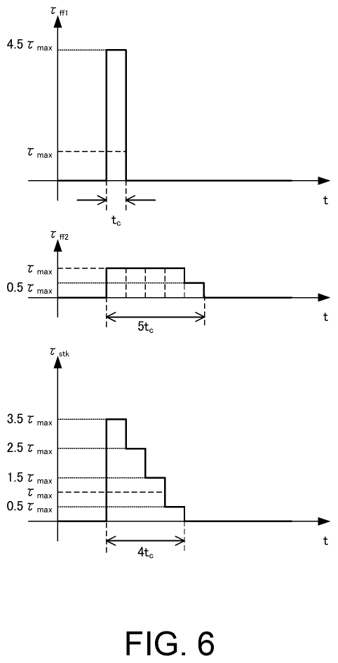

A specific example of the processing according to FIG. 4 and FIG. 5 will be described with reference to FIG. 6. FIG. 6 includes graphs showing examples of the first FF torque command value τff1, the second FF torque command value τff2, and the integral value τstk. In the example of FIG. 6, the first FF torque command value τff1 has an impulse function shape of 4.5×τmax. In this case, naturally, τff1>τmax, and therefore, the second FF calculation unit 24 outputs τff2=τmax and sets τstk=τff1−τmax=3.5×τmax.

In the next control cycle tc, since τstk>τmax and τff1=0, the second FF calculation unit 24 outputs τff2=τmax and sets τstk=τstk−τmax=2.5×τmax. This process is repeated two more times, resulting in τstk=0.5×τmax. In this case, the second FF calculation unit 24 outputs τff2=τstk=0.5×τ and sets τstk=0.

As is clear from the above explanation, in the present example the time integral of the second FF torque command value τff2 is the same as the time integral of the first FF torque command value τff1. As a result, even when the first FF torque command value τff1 is output only momentarily, the second FF torque command value τff2 is output continuously. This enables the responsiveness of the motor 32 to be maintained at a high level.

The configuration of the present example is effective not only when the first FF torque command value τff1 has an impulse function shape, but also when it has other waveform shapes. For example, the case where the speed command value V* has a ramp function shape, as shown in FIG. 7, will be considered. In this case, the first FF torque command value τff1 has a step function shape. At this time, when the sum of the previous integral value τstk and the current first FF torque command value τff1 exceeds the maximum motor torque τmax, τff2=τmax is output. Furthermore, the output τff2 is subtracted from the integral value τstk. By repeating this process, the second FF torque command value τff2 is output even after time t1 when the first FF torque command value τff1 becomes 0. Finally, the time integral of the second FF torque command value τff2 can be made to coincide with the time integral of the first FF torque command value τff1. This allows the speed of the motor 32 to appropriately follow the speed command value V*.

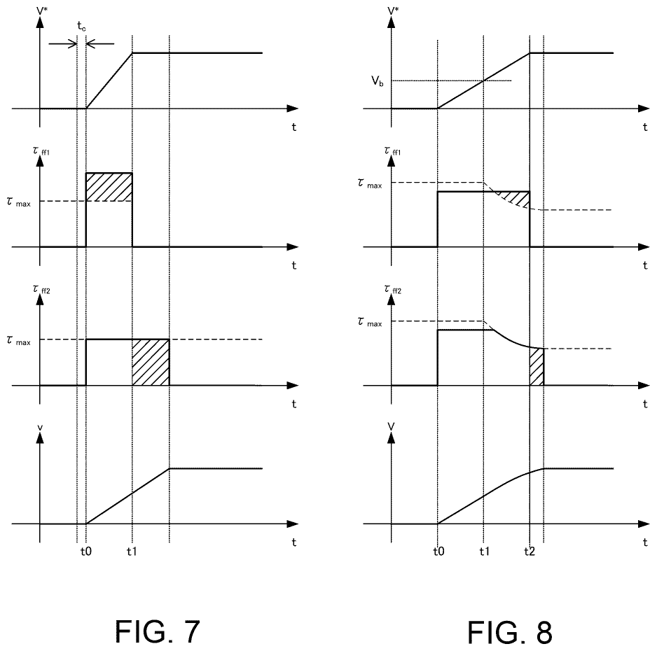

The case where the speed command value V* exceeds the base speed Vb as it increases, as shown in FIG. 8, will also be considered. As is clear from Equations 2 and 3, the maximum motor torque τmax decreases when the speed command value V* of the motor 32 exceeds the base speed Vb. Therefore, in the example of FIG. 8, the maximum motor torque τmax changes as shown by the curve indicated by the dashed line. Even in this case, the portion of the first FF torque command value τff1 that exceeds the maximum motor torque τmax is output as the second FF torque command value τff2. In other words, according to the present example, the portion of the first FF torque command value τff1 that exceeds the maximum motor torque τmax can be held as the integrated value τstk. As a result, the time integral of the second FF torque command value τff2 can be made to coincide with the time integral of the first FF torque command value τff1. This allows the speed of the motor 32 to appropriately follow the speed command value V*.

The above configurations are all examples. So long as they satisfy the configuration of Claim 1, the other features may be changed as appropriate. For example, in the above description, the example has been given in which τff2=τmax when τff1>τmax, but the second FF torque command value τff2 may be smaller than the maximum motor torque τmax. When the second FF torque command value τff2 is set to be smaller than the maximum motor torque τmax, the second FF torque command value τff2 may be output for a correspondingly longer period of time. In addition, in FIG. 1 and FIG. 3, the areas surrounded by dashed rectangles may be configured by a computer having a processor and a memory.

### REFERENCE SIGNS LIST

10, 10*, 10** motor control device, 12 command generation unit, 14 subtracter, 16 speed control unit, 18 filter processing unit, 20 differentiator, 22 first FF calculation unit, 24 second FF calculation unit, 26 adder, 28 limit processing unit, 30 current control unit, 32 motor, 34 target plant.

1. A motor control device comprising:
a speed control unit that outputs a torque command value based on a speed deviation that is a difference between a speed command value and a detected speed value,
a first feedforward calculation unit that calculates a first feedforward torque command value corresponding to the amount of change in the speed command value,
a second feedforward calculation unit that, when the first feedforward torque command value exceeds a maximum motor torque, outputs a second feedforward torque command value smaller than or equal to the maximum motor torque for a period longer than a period during which the first feedforward torque command value exceeds the maximum motor torque, and adds the second feedforward torque command value to the torque command value, and
a current control unit that controls a motor current based on the torque command value.

2. The motor control device according to claim 1, wherein the second feedforward calculation unit calculates an acceleration/deceleration time period for a motor based on the inertia of the motor, the inertia of an object to be controlled, and the maximum motor torque, and outputs the maximum motor torque as the second feedforward torque command value during the acceleration/deceleration time period.

3. The motor control device according to claim 2, wherein
the speed command value has a step function shape, and the first feedforward torque command value has an impulse function shape, and
the second feedforward calculation unit calculates the acceleration/deceleration time period ta based on Equation 1:
$$ta = ( {J}_{m} + {J}_{w} ) {\int }_{{V}_{0}}^{{V}_{r}} \frac{V}{{τ}_{max} ( V )} dV \qquad Equation 1$$
where Vᵣ is the speed command value after the speed command value changes in a stepwise manner, V₀ is an initial speed command value before the speed command value changes in the stepwise manner, Jₘ is the motor inertia, J_{w} is the motor shaft-converted load inertia of the object to be controlled, and τₘₐₓ is the maximum motor torque.

4. The motor control device according to claim 1, wherein the second feedforward calculation unit outputs, after the first feedforward torque command value that exceeds the maximum motor torque is calculated, the maximum motor torque as the second feedforward torque command value until the speed deviation becomes smaller than or equal to a predetermined reference value.

5. The motor control device according to claim 1, wherein the second feedforward calculation unit calculates a second feedforward torque command value such that a time integral value of the second feedforward torque command value is equal to a time integral value of the first feedforward torque command value.

6. The motor control device according to claim 5, wherein, for each control cycle, the second feedforward calculation unit
calculates an intermediate torque command value by adding the first feedforward torque command value to a current time integral value,
outputs the smaller of the intermediate torque command value and the maximum motor torque as the second feedforward torque command value, and
calculates a new integral value by adding the first feedforward torque command value to the integral value and subtracting the second feedforward torque command value from the integral value.

7. The motor control device according to claim 1, wherein
the maximum motor torque is a torque limit value predetermined by the motor control device, or an actual maximum torque, and
the actual maximum torque is defined by Equations 2 and 3:
$${τ}_{max} ( V ) = \frac{{P}_{max}}{{V}_{b}} ( V \leq {V}_{b} ) \qquad Equation 2$$
$${τ}_{max} ( V ) = \frac{{P}_{max}}{V} ( {V}_{b} < V ) \qquad Equation 3$$
where Pₘₐₓ is a maximum motor output, V_{b} is the base motor speed, and V is the motor speed.
